(19) United States
(12) Patent Application Publication
(10) Pub. No.: US 2024/0262625 A1
(43) Pub. Date: Aug. 8, 2024

(54) MULTI-LEVEL SORTING SYSTEM

(71) Applicant: Aquabot Ltd., Afula (IL)

(72) Inventors: Joseph Zvi PORAT, Highland Beach, FL (US); Shay GABRIELI, Ramat Yishai (IL); Yigal Natan RINGART, Givat Ela (IL)

(73) Assignee: Aquabot Ltd., Afula (IL)

(21) Appl. No.: 18/564,250

(22) PCT Filed: May 26, 2022
(86) PCT No.: PCT/IL2022/050561

§ 371 Date: Nov. 27, 2023

Related U.S. Application Data
(60) Provisional application No. 63/193,672, filed on May 27, 2021.
(60) Provisional application No. 63/196,239, filed on Jun. 3, 2021.

(51) Int. Cl. B65G 1/137; B07C 3/08; B65G 11/02

(52) U.S. Cl. CPC B65G 1/137; B07C 3/08; B65G 11/02; B65G 2201/0285

(57) ABSTRACT

A multi-level sorting system may include a multi-level structure comprising: a plurality of chutes; a plurality of distribution floors, to deliver items for distribution to any of a plurality of unique address bins, each of the distribution floors located at a different level and comprising a network of lanes for independently operating a plurality of transporter carts on the network of lanes. The network of lanes of each of the floors includes a feeding lane to transport the items for distribution to at least one loading lane; a plurality of automated inductors along said at least one loading lane, to pick one of the items and load that item onto one of the transport carts; and a plurality of unloading lanes with unique unloading positions arranged so that unique unloading positions that are located at different floors and that are assigned to a single unique address bin, are each substantially aligned with an inlet of a shared chute of the plurality of chutes.

### FIELD OF THE INVENTION

The present invention relates to a system for transporting and sorting items. More particularly, the present invention relates to a multi-level sorting system, which may be suitable, for example, for high capacity multiple order fulfilment centers.

### BACKGROUND OF THE INVENTION

Logistics hubs, delivery centers, warehouses and similar facilities are typically tasked with receiving incoming packages or parcels and sorting them to their destinations. Incoming parcels may arrive from several sources, and may have final destinations worldwide, nationwide etc. For example, in electronic commerce (e-commerce) a customer that is located anywhere in the world may remotely place an order for an item, e.g., via the Internet or via another network. The ordered item may originate from various different warehouses or manufacturing facilities. In the case of large e-commerce marketplace websites, the ordered items may originate from various different providers. Generally, the goal of an e-commerce vendor is to provide as many ordered articles as possible in a minimum amount of time.

Sorting systems may include a network of conveyor belts to transport the parcels from a loading station to a destination bin of the parcel, from which that parcel may be transported to the desired destination.

Multiple parcels may be transported to the same destination station. For example, in a fulfilment center where a user orders a package with multiple items, the multiple parcels are transported from their respective storage areas through a sorting system to their destination station. When the items are transported to their destination station, the items may be processed, packaged and/or transported for a different location.

Transporting multiple parcels on the same conveyor belt may cause congestion on the conveyor belt and delay the transport of the parcels. At a given time multiple parcels may be transported to one or multiple destinations on the same sorting system and progress along the sorting system at a limited speed dictated by the throughput rate of that system. The speed at which the parcels may progress may be limited due to multiple factors, some of which are operational limits of the sorting system or safety limitations of the sorting system and transporting elements, and handling time of the parcels (e.g., the total time a parcel is handled by the sorting system from loading until it is dropped at its destination bin.

The rate of parcel transportation may also limit the whole operation of sorting. Typically, increasing capacity leads to an increase in the area of the sorting system, as adding more lanes (e.g., side by side) will increase the footprint of the sorting system.

Sorting systems generally occupy the floor of a warehouse or a fulfilment center, and typically take up a considerable area of the floor. Scaling the sorting systems, for increasing capacity of the sorting system or rate of parcel handling and transport, may require increasing the area of the sorting systems.

It may be desirable to provide a sorting system that scales horizontally and vertically as well for increased throughput.

### SUMMARY OF THE INVENTION

There is provided, in accordance with some embodiments of the present invention, a multi-level sorting system. The system may include a multi-level structure comprising: a plurality of chutes; and a plurality of distribution floors, each of the distribution floors located at a different level and comprising a network of lanes for independently operating a plurality of transporter carts on the network of lanes, The network of lanes of each of the floors may include a feeding lane to transport items for distribution to at least one loading lane; a plurality of automated inductors along said at least one loading lane, each of the automated inductors configured to pick one of the items and load that item onto one of the transport carts; and a plurality of unloading lanes with unique unloading positions arranged so that unique unloading positions of the unique unloading positions that are located at different floors of the plurality of distribution floors and that are assigned to a single unique address bin of a plurality of unique address bins, are each substantially aligned with an inlet of a shared chute of the plurality of chutes.

According to some embodiments of the present invention, the system further includes a plurality of exit lanes adjacent outlets of the chutes for transporting one or a batch of the items that was collected in each of the unique address bins to be packaged and shipped.

According to some embodiments of the present invention, the lanes are one-way lanes.

According to some embodiments of the present invention, the plurality of unloading lanes are substantially parallel to each other.

According to some embodiments of the present invention, the plurality of unloading lanes are linked by connection lanes.

According to some embodiments of the present invention, a feeding lane is configured to transport the items for distribution in boxes.

According to some embodiments of the present invention, the system further includes a box evacuation elevator to evacuate the boxes after the boxes are emptied.

According to some embodiments of the present invention, the system further includes empty box feeding lanes to feed boxes for packaging of the one or a batch of the items that was collected in each of the unique address bins.

According to some embodiments of the present invention, the system further includes at least one feeding lane for receiving one or a plurality of items dispatched by a drone.

According to some embodiments of the present invention, the at least one feeding lane for receiving one or a plurality of items dispatched by the drone comprises a gate with a sensor for identifying said one or a plurality of items dispatched by the drone or for obtaining data pertaining to said one or a plurality of items dispatched by the drone.

According to some embodiments of the present invention, the system further includes a rerouting device for removing an item of said one or a plurality of items dispatched by the drone from the feeding lane upon determining that that item was not ordered.

According to some embodiments of the present invention, the plurality of unloading lanes comprises magnetic levitation tracks.

According to some embodiments of the present invention, each of the plurality of chutes comprises a controllable opening at the bottom.

According to some embodiments of the present invention, the controllable opening comprises a dropping floor.

According to some embodiments of the present invention, each of the plurality of chutes comprises fall retardant slopes.

According to some embodiments of the present invention, the plurality of chutes are vertical chutes.

According to some embodiments of the present invention, the plurality of chutes comprise at least partially an inclined portion,

According to some embodiments of the present invention, there is provided a multi-level sorting method. The method may include providing a multi-level structure comprising: a plurality of chutes; a plurality of distribution floors, delivering items for distribution to any of a plurality of unique address bins, each of the distribution floors located at a unique level and comprising a network of lanes on which a plurality of transporter carts are independently operated wherein the network of lanes of each of the floors comprises: transporting the items for distribution on a feeding lane to and along at least one loading lane; using a plurality of automated inductors along the loading lane, each of the automated inductors to pick one of the items and load that item onto one of the transport carts; and providing a plurality of unloading lanes with unique unloading positions arranged so that unloading positions of the unique unloading positions of different floors of the plurality of distribution floors that are substantially vertically aligned are each located at an inlet of a shared chute of the plurality of chutes acting as a unique address bin of the unique address bins; and providing a plurality of exit lanes adjacent outlets of the chutes for transporting one or a batch of the items that was collected in each of the unique address bins to be packaged and shipped.

### BRIEF DESCRIPTION OF THE DRAWINGS

In order for the present invention to be better understood and for its practical applications to be appreciated, the following Figures are provided and referenced hereafter. It should be noted that the Figures are given as examples only and in no way limit the scope of the invention. Like components are denoted by like reference numerals.

FIG. 1 is an isometric view of a sorting system, in accordance with some embodiments of the present invention.

FIG. 2 is an isometric view of a sorting system, from a different viewing angle, in accordance with some embodiments of the present invention, showing item feeding lanes, exit lanes of packages and loading stations.

FIG. 3 is an isometric view of a sorting system, from yet another different viewing angle, in accordance with some embodiments of the present invention, showing the back of the system, a box evacuation elevator and empty box feeding lane.

FIG. 4 item feeding lanes of a sorting system, in accordance with some embodiments of the present invention.

FIG. 5 shows a vertical cross section of a chute of a multi-level sorting system, in accordance with some embodiments of the present invention.

FIG. 6 shows a vertical cross section of a dual chute of a multi-level sorting system, in accordance with some embodiments of the present invention.

FIG. 7 shows an inclined dual chute of a multi-level sorting system, in accordance with some embodiments of the present invention.

FIG. 8 shows an alternative arrangement for conveying empty boxes and boxes filled with a batch of ordered items of a multi-level sorting system, in accordance with some embodiments of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

Some embodiments of the invention may include an article such as a computer or processor readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein.

A multi-level sorting system according to some embodiments of the present invention includes a multi-level structure of a plurality of distribution floors, with a plurality of unique unloading positions on each floor, so that unloading positions that are aligned substantially one on top of the other, so that corresponding unloading positions of a single unique address bin are located adjacent to inlets of a shared chute. Such arrangement allows increasing the processing rate of items through the system while maintaining the same footprint in terms of area occupied by the system. Having shared chutes allows for collecting ordered items of a single order into a single batch quickly and conveniently, placing all the items of that batch in a single box (or other packaging method) to be shipped in a single shipment rather than shipping each item of an order separately.

According to some embodiments of the invention each distribution floor includes a network of lanes on which each of a plurality of transporter carts is independently operated.

The transporter car can be, for example, a cart with a tiltable platform that is operated remotely, for example over magnetic levitation tracks, and electrically linked to a controller that controls the operation of each of the carts based on knowing the location of each of the carts at any given time and that operates the tiltable platform, so as to drop an item that is on that platform at a designated unloading position.

According to some embodiments of the invention, the network of lanes of each of the distribution floors may include a feeding lane to transport the items for distribution to and along at least one loading lane.

A plurality of automated inductors may be positioned along the loading lane/s, each of the automated inductors configured to pick one of the items and load that item onto one of the transport carts. The automated inductors may be, for example, robotic arms, for picking an item off the feeding lane and placing that item on carrier platform of a transporter cart.

According to some embodiments of the invention, the automated inductor may include a sensor for optically or electrically sensing an item and identifying the item and/or its destination (e.g., shipping address).

The transporter carts may be designed to travel over the network of lanes that includes a plurality of unloading lanes with unique unloading positions. A Controller may control the operation of the sorting system, for example, by identifying ordered items using sensors, operating the automated inductors to correctly pick ordered items and placing them on the transporter carts and operating each of the transporter carts based on knowledge of the current position of each of the transporter carts.

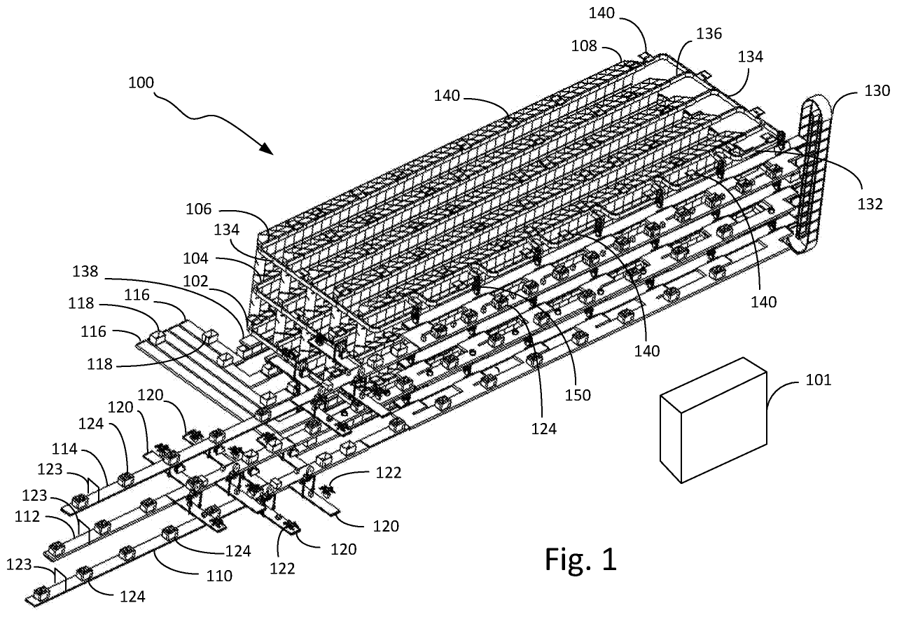

FIG. 1 is an isometric view of a sorting system 100, in accordance with some embodiments of the present invention.

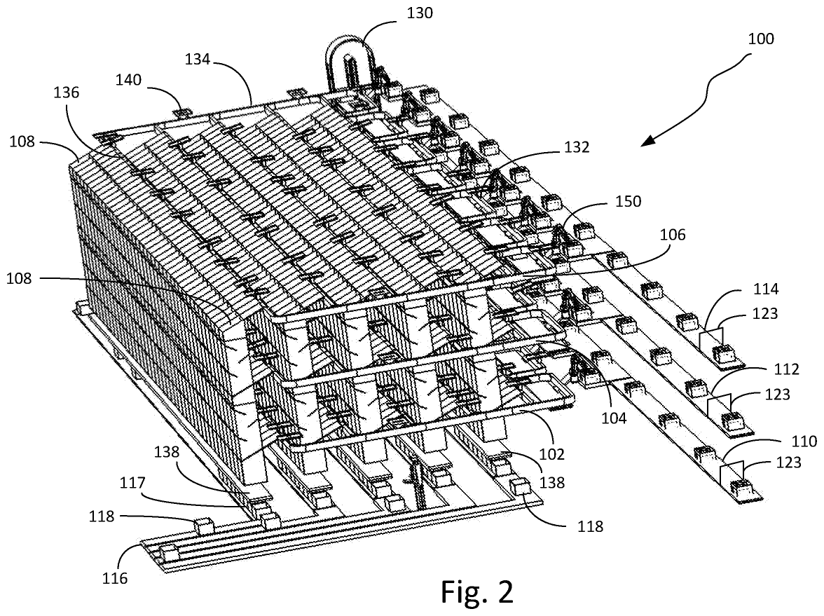

FIG. 2 is an isometric view of a sorting system, from a different viewing angle, in accordance with some embodiments of the present invention, showing item feeding lanes, exit lanes of packages and loading stations.

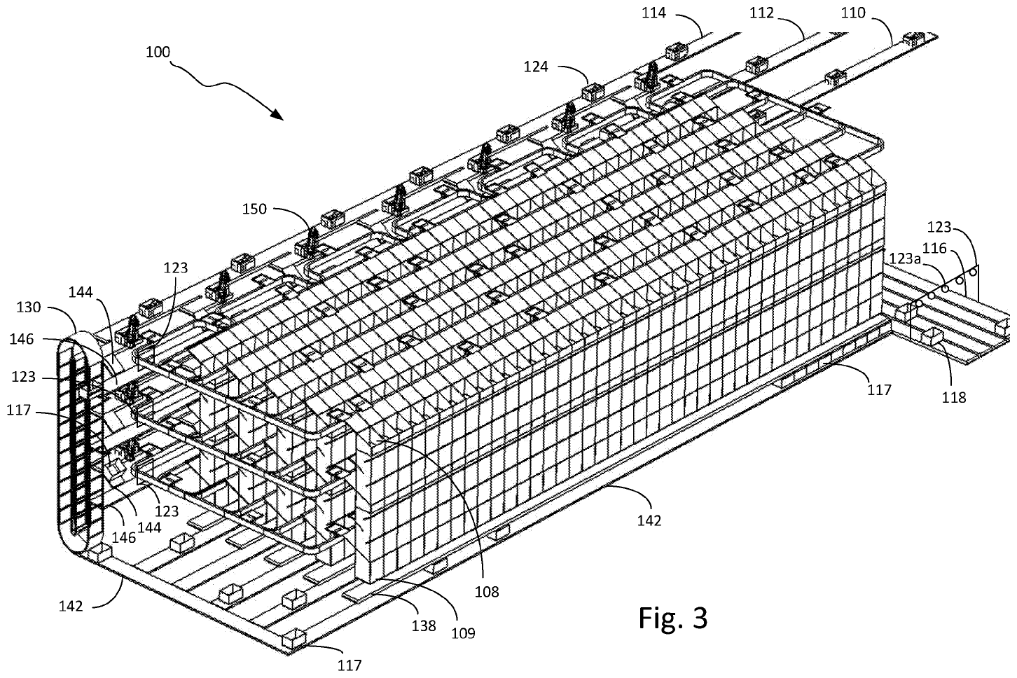

FIG. 3 is an isometric view of a sorting system, from yet another different viewing angle, in accordance with some embodiments of the present invention, showing the back of the system, a box evacuation elevator and empty box feeding lane.

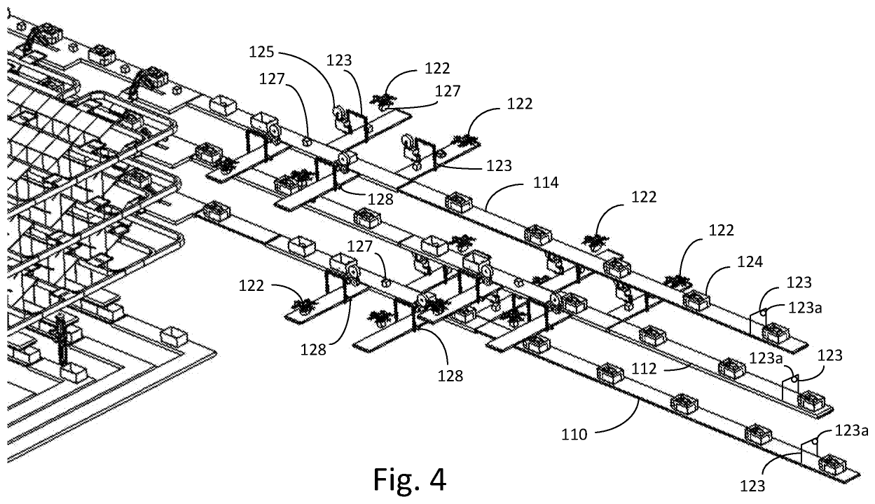

FIG. 4 item feeding lanes of a sorting system, in accordance with some embodiments of the present invention.

Sorting system 100 may include a multi-level structure that includes several distribution floors 102, 104 and 106, which are substantially vertically aligned (one on top of the other).

Feeding lanes 110, 112 and 114 may be configured to feed items for distribution to the distribution floors 102, 104 and 106 respectively. The feeding lanes may include, for example one or a plurality of conveyor belts or conveyor tracks on which separate items or items boxed in item boxes 124 may be conveyed. The term “boxes” may refer to various types and kinds of containers for holding and transporting same or various items pertaining to one or a plurality of orders, such as, but not limited to, boxes, totes, trays, platforms, tins, bins and so on. These boxes preferably have, each, a top wide opening that allows for a clear view of the box content, if it is to be scanned by an optical scanner, and uninterrupted reach so as to allow picking of any of the items on that box by an inductor or other picking device.

Additionally or alternatively, one or more feeding lanes, e.g., side feeding lanes 120, may be configured to receive one or a plurality of items delivered by a drone.

Feeding lanes may include, for example, a gate 123 (see FIG. 4) that includes, for example, a sensor 123a (e.g., optical sensor, electronic sensor) for identifying an item 127 that was delivered by the drone 122 and/or for sensing one or a plurality of properties of the item 127, for example, identifying the order on which it was ordered and/or address to which it should be shipped, and/or other identifying information, or for identifying items placed in an item box, as long as such items are in a clear field of view or within the sensing range of the gate's sensor 123a.

A rerouting device 128, such as, for example, a lever, a robotic arm, a spring or other suitable device, may be provided, designed to remove the delivered item if it is determined that it was not included in any of the orders being processed by the sorting system.

Printer 125 may print a label which is then applied on the item to facilitate identification of the item or determining shipping address.

A drone may be used to deliver any item. For example, a drone may be found useful in delivering medications, jewelry and/or any other delicate, precious, or specifically monitored items.

The items on the feeding lanes may be conveyed until they are within reach of one of the automated inductors 150 (FIG. 3) that are located adjacent to the loading lane 132 (FIG. 2) of the distribution floor.

The automated inductors 150 may include a video recognition system to allow identification of an item and allocation of that item to a specific address bin destination.

Automated inductor 150 may pick an item off the feeding lane and load it on a transporter cart 140, for example by placing the item on a tiltable platform of the cart.

The transporter cart may then proceed to travel over the loading lane via connection lane/s 134 and reach an unloading lane 136 that has a unique unloading position at an inlet of a chute temporarily assigned the unique address bin that the item has to be delivered to.

The connection lane 134 may include a video recognition system, e.g., in gate 123, to allocate the specific inducted item that was just placed on the platform of a transporter cart to its specific unique address bin destination.

Controller 101 may be provided to control the operation of the sorting system, according to some embodiments of the present invention.

The controller may comprise one or a plurality of processors, housed in a single housing or distributed locally and/or remotely.

Controller 101 may control the operation of various components/functions of the sorting system, such as, for example, power, communications, feeding, induction, sorting, chutes and bins, outlets. For example, the controller 101 may control the operation of conveyor motors, item recognition sensors, (e.g., at the gates, at the induction points, such as at the robotic arms), position sensors, safety sensors and other types of sensors, provide traffic control, track position and control operation of the transporter carts, manage the tiltable platforms of the transporter carts, control the automated inductors (e.g., robotic arms), control chute selection, control the chutes and emptying of the unique address bins, control packaging and shipment of packaged orders, and any other components and functions that are needed to properly operate the sorting system.

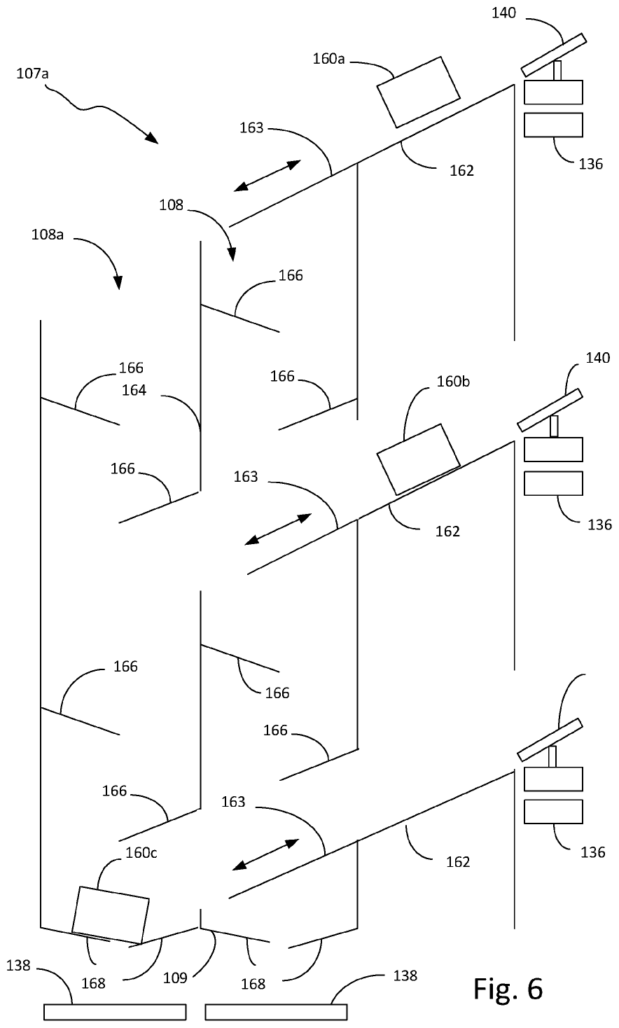

For example, controller 101 may perform some or all of the following functions:
a) receive a batch of orders and analyze them for all items ordered and send the list to the warehouse for pick-up;
b) identify each item fed onto the feeding lanes 110, 112, 114;
c) allocate identified item/s to a specific order;
d) expel from the feeding lanes any item that was unrecognized or not associated to any order and send these expelled items to a designated location;
e) assign a unique address bin to a specific order;
f) control induction by automated inductors 150, to pick the items from the item boxes 124, and place them, separately, on incoming transporter carts 140;
g) direct each transporter cart to the proper unique address bin, taking the shortest route, and instruct it to stop at the proper unloading position and drop the item into the correct chute 108;
h) send the transporter cart after unloading for loading at a nearest loading location, to be loaded with a new item and transporting that item to the correct unique address bin;
i) tracking orders until completion;
j) controlling the sliding doors of a chute (such as in a dual chute arrangement, see FIG. 6 and related explanation in the present specification hereinafter);
k) once a unique address bin (a chute) is cleared of all items of an order, assign that unique address bin a new order;
l) analyzing each order entered into the system and send a pick-up request of all items in that order to the warehouse.
m) updating status of completed orders for picked/missing items; and
n) instruct a printer or printers to print an order details sheet.

The above list is not necessarily a complete list of functions, and controller 101 may be programmed to perform additional or alternative functions as may be needed.

A sorting system according to some embodiments of the present invention may operate in various operation modes.

Upon commencing work, the controller 101 may receive information on a first order that includes a batch of ordered items, all pertaining to one addressee (e.g., to be processed and forwarded to a single customer). The controller may analyze the orders to determine what items are included in these orders and send a pick-up request to the storage location of the items (e.g., the warehouse these items are stored in). These items may then be forwarded to the sorting system and fed into it via the feeding lane/s. One or more inducers (e.g., pickers, such as robotic arms, drones, dispensers, and other inducers) may then obtain the items and place each of them, separately, on the platforms of the transporter carts. The controller manages the controlled components of the sorting system to successfully deliver the ordered items of that order, using the lane network of one or several distribution floors, to a single chute assigned the unique address bin associated with the addressee of the order.

According to some embodiments of the invention the controller may determine whether to use one or more levels of the multi-level sorting system, depending on the current or anticipated work load.

The provision of a multi-level distribution floor structure allows for a faster and/or more efficient distribution, which may yield higher throughput and greater volume of processing.

After the first order, additional orders may arrive in waves or continuously. When the orders arrive in waves the warehouse may handle delivery requests more efficiently, as the controller may order all items for the wave of orders concurrently, where when handling the orders continuously item requests will be handled separately.

As soon as a chute (temporarily acting as a specific unique address bin) is emptied of the items of an order it may be assigned a new temporary unique address bin and accept items of a new order.

According to some embodiments of the present invention, the controller may operate the sorting system in a dynamic manner, using only one or some of the distribution levels when the work load is low, or using all of the distribution levels when high capacity handling of orders is desired.

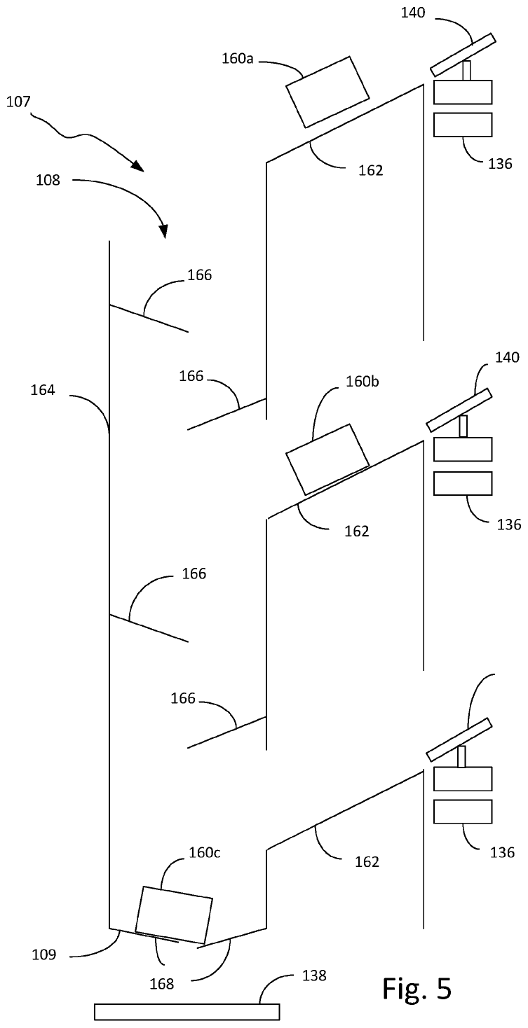

FIG. 5 shows a vertical cross section of a chute of a multi-level sorting system, in accordance with some embodiments of the present invention.

When the transporter cart dispatches the item at the appropriate unloading position that item slides over an entry slope 162 and drops into the pier of chute 108 defined by side wall 164. Fall retardant slopes 166 may be provided on the inner wall of chute 108 to soften the fall of items into the chute so as to prevent damage to the item that may be inflicted when free-falling.

FIG. 6 shows a vertical cross section of a dual chute of a multi-level sorting system, in accordance with some embodiments of the present invention.

In the dual chute configuration 107a a second chute shaft 108a adjacent to the first chute shaft 108 may be provided, aligned with the first chute shaft 108. A slanted sliding door 163 (or other arrangement, for example a drop door) may be provided which is movable between an opened and a closed position. When the sliding 163 door is in the open position an item that is dropped by a transporter cart at the unloading position adjacent to that chute will slide over the chute entry slope 162 and fall into chute shaft 108. When the sliding door 163 is in the closed position, the dropped item (e.g., 160a) will slide further across the closed slanted sliding door 163 and drop into the adjacent second shaft 108a of chute 107a. A dual chute arrangement may allow doubling the number of unique address bins. Similarly, in additional chute shafts are provided the number of unique address bins may be increased.

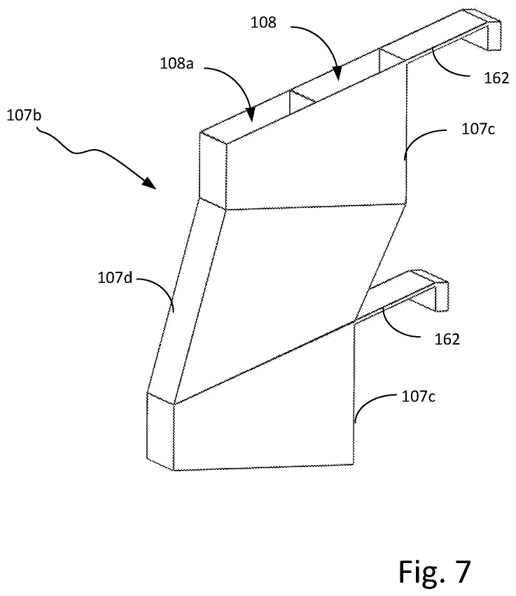

FIG. 7 shows an inclined dual chute 107b of a multi-level sorting system, in accordance with some embodiments of the present invention.

Chute 107b may be fully or partially inclined. In the example shown in this figure chute 107b has some vertical parts 107c and an inclined portion 107d. In other embodiments various other arrangements may be provided. The inclination of the chute may slow down the falling velocity of items dropped into that chute so as to reduce the danger of inflicted damage to the dropped items during the fall. When the controller determines that an entire batch of ordered items was delivered to a specific chute acting as a unique address bin for that order, the opening 168 at the bottom of the chute 109 may be operated to drop all of the items of that batch onto a batch exit lane 138 that transports the items of the batch grouped together to the end of the batch exit lane, where it may drop into an empty 117 box that was waiting for a batch at the end of the batch exit lane 138. The box may pass through an automated inspection gate 123 to verify the order content. The box with a completed batch of ordered items 118 may be transported over exit lane 116 of the packages to be packed (e.g., in the same box or transferred into some other container or wrapping for shipping (e.g., box, wrap, bag, envelope etc.) and labeled for further shipment.

When an incoming item box 124 is emptied (at any of the inductor stations) it may be evacuated via empty boxes conveyor 142 that transfers the empty boxes away. Slope 144 for empty boxes may be provided to direct each of the empty item boxes to a box descending device 130 (e.g., an electrically operated lift, gravity operated wheel or other such device).

Box descending device 130 may be configured to transfer the empty boxes to the bottom of the sorting system and dispatch the empty boxes on empty box feeding lane 142 to be used in the sorting system or sent elsewhere for refilling with new order items.

According to some embodiments of the invention, the lanes of the network of lanes are one-way lanes. The transporter carts travel on these lanes unidirectionally.

The plurality of unloading lanes may be substantially parallel to each other, and parallel to each other. Linked by connection lanes.

In some embodiments the feeding lanes are configured to transport the items for distribution in boxes. In some other embodiments of the invention feeding lanes are configured to transport each of the items for distribution separately, distanced from other items.

The sorting system, according to some embodiments of the invention may include one or more empty box feeding lanes 142 to feed boxes for packaging of the one or a batch of the items that was collected in each of the unique address bins.

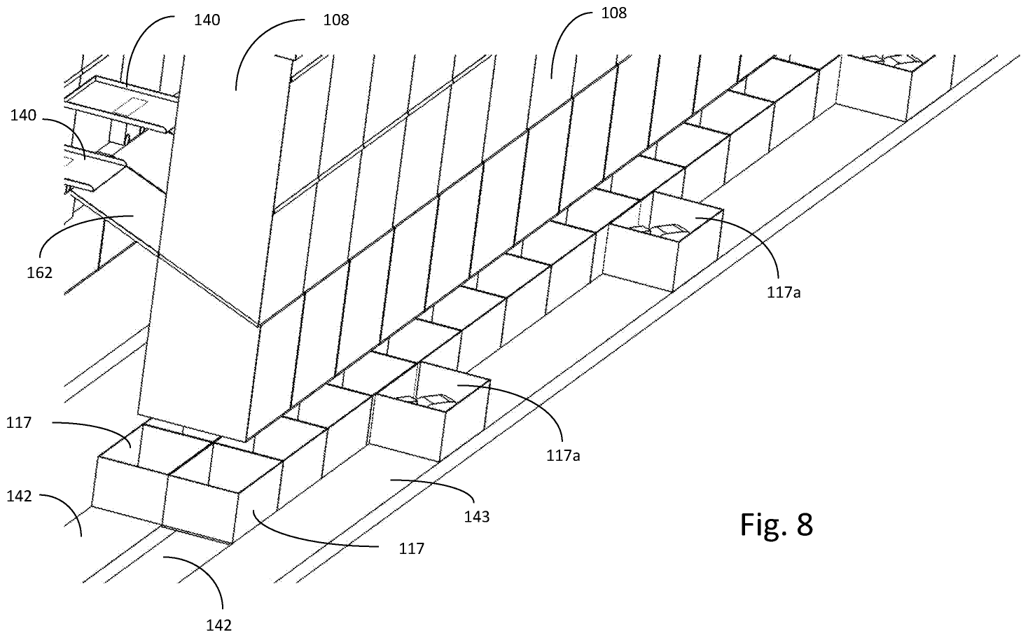

FIG. 8 shows an alternative arrangement for conveying empty boxes and boxes filled with a batch of ordered items of a multi-level sorting system, in accordance with some embodiments of the present invention.

According to some embodiments of the invention two juxtaposed empty box conveyors 142 may be provided, one of which is configured to convey empty boxes 117 and force them to group along a line so that each of the empty boxes 117 is positioned beneath the bottom of a chute, and another that is configured to convey empty boxes and force them to group along a line parallel to the empty box line beneath the chutes. When a certain box 117 is filled with a complete batch of ordered items, conveyor 114 is configured to shift that box sideways to conveyor 143 for boxed filled with a batch of ordered items, that conveys that box to be automatically and/or manually inspected to verify the order content. further packaged and shipped, while at the same time an empty box from the juxtaposed conveyor 142 is moved sideways to take up the position of the filled box that was taken away.

Different embodiments are disclosed herein. Features of certain embodiments may be combined with features of other embodiments such that certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

Index of elements shown in the appended figures is provided hereinafter:
100—multi-level sorting system;
101—controller;
102, 104 and 106—first floor, second floor and third floor, respectively, of multi-level sorting system;
107—chute;
107a—dual chute;
107b—inclined chute;
107c—vertical portion of chute;
107d—inclined portion of chute;
108—chute shaft;
108a—second chute shaft;
109—bottom of the chute;
110, 112 and 114—feeding lanes of first, second and third floors, respectively;
116—exit lanes of packages;
117—empty boxes;
117a—box filled with a batch of ordered items;
118—box with a completed batch of ordered items at exit from the multi-level sorting system;
120—side feeding lane;
122—drone;
123—item verification gate;
123a—item verification sensor;
124—item box;
125—printer;
127—item;
128—rerouting device;
130—box descending device;
132—loading lane;
134—connection lane;
136—unloading lane;
138—batch exit lane;
140—carrier cart with tiltable platform;
142—empty boxes conveyor;
143—conveyor for boxed filled with a batch of ordered items;
144—slope for emptied item boxes;
146—lane for empty item boxes;
150—robotic arm;
160a, 160b and 160c—ordered items;
162—chute entry slope;
163—sliding door
164—side wall of chute;
165—side wall of adjacent chute (in a dual chute configuration);
166—fall retardant slope;
168—opening;

1. A multi-level sorting system comprising:
a multi-level structure comprising:
a plurality of chutes;
a plurality of distribution floors, each of the distribution floors located at a different level and comprising a network of lanes for independently operating a plurality of transporter carts on the network of lanes, wherein the network of lanes of each of the floors comprises:
a feeding lane to transport items for distribution to at least one loading lane;
a plurality of automated inductors along said at least one loading lane, each of the automated inductors configured to pick one of the items and load that item onto one of the transport carts; and
a plurality of unloading lanes with unique unloading positions arranged so that unique unloading positions of the unique unloading positions that are located at different floors of the plurality of distribution floors and that are assigned to a single unique address bin of a plurality of unique address bins, are each substantially aligned with an inlet of a shared chute of the plurality of chutes.

2. The system of claim 1, further comprising a plurality of exit lanes adjacent outlets of the chutes for transporting one or a batch of the items that was collected in each of the unique address bins to be packaged and shipped.

3. The system of claim 1, wherein the lanes are one-way lanes.

4. The system of claim 1, wherein the plurality of unloading lanes are substantially parallel to each other.

5. The system of claim 4, wherein the plurality of unloading lanes are linked by connection lanes.

6. The system of claim 1, wherein a feeding lane is configured to transport the items for distribution in boxes.

7. The system of claim 5, further comprising a box evacuation elevator to evacuate the boxes after the boxes are emptied.

8. The system of claim 7, further comprising empty box feeding lanes to feed boxes for packaging of the one or a batch of the items that was collected in each of the unique address bins.

9. The system of claim 1, further comprising at least one feeding lane for receiving one or a plurality of items dispatched by a drone.

10. The system of claim 9, wherein the at least one feeding lane for receiving one or a plurality of items dispatched by the drone comprises a gate with a sensor for identifying said one or a plurality of items dispatched by the drone or for obtaining data pertaining to said one or a plurality of items dispatched by the drone.

11. The system of claim 9, further comprising a rerouting device for removing an item of said one or a plurality of items dispatched by the drone from the feeding lane upon determining that that item was not ordered.

12. The system of claim 1, wherein the plurality of unloading lanes comprises magnetic levitation tracks.

13. The system of claim 1, wherein each of the plurality of chutes comprises a controllable opening at the bottom.

14. The system of claim 13, wherein the controllable opening comprises a dropping floor.

15. The system of claim 1, wherein each of the plurality of chutes comprises fall retardant slopes.

16. The system of claim 1, wherein the plurality of chutes are vertical chutes.

17. The system of claim 1, wherein the plurality of chutes comprise at least partially an inclined portion.

18. A multi-level sorting method comprising:
providing a multi-level structure comprising:
a plurality of chutes;
a plurality of distribution floors,
delivering items for distribution to any of a plurality of unique address bins, each of the distribution floors located at a unique level and comprising a network of lanes on which a plurality of transporter carts are independently operated wherein the network of lanes of each of the floors comprises:
transporting the items for distribution on a feeding lane to and along at least one loading lane;
using a plurality of automated inductors along the loading lane, each of the automated inductors to pick one of the items and load that item onto one of the transport carts; and
providing a plurality of unloading lanes with unique unloading positions arranged so that unloading positions of the unique unloading positions of different floors of the plurality of distribution floors that are substantially vertically aligned are each located at an inlet of a shared chute of the plurality of chutes acting as a unique address bin of the unique address bins; and
providing a plurality of exit lanes adjacent outlets of the chutes for transporting one or a batch of the items that was collected in each of the unique address bins to be packaged and shipped.
